(19) United States
(12) Patent Application Publication
(10) Pub. No.: US 2018/0179429 A1
(43) Pub. Date: Jun. 28, 2018

(54) Thermal Interface Material, Method For Preparing Thermal Interface Material, Thermally Conductive Pad, And Heat Dissipation System

(71) Applicant: HUAWEI TECHNOLOGIES CO., LTD., Shenzhen (CN)

(72) Inventors: Mizuhisa NIHEI, Yokohama (JP); Xiaosong ZHOU, Shenzhen (CN); Keishin OTA, Ibaraki (JP)

(21) Appl. No.: 15/890,164

(22) Filed: Feb. 6, 2018

Related U.S. Application Data
(63) Continuation of application No. PCT/CN2016/090003, filed on Jul. 14, 2016.

(30) Foreign Application Priority Data
Dec. 29, 2015 (CN) 201511009829.9

(51) Int. Cl. C09K 5/14; F28F 3/00; F28F 21/02

(52) U.S. Cl. CPC C09K 5/14; B82Y 40/00; F28F 21/02; F28F 3/00

(57) ABSTRACT

A thermal interface material, a method for preparing a thermal interface material, a thermally conductive pad, and a heat dissipation system are provided. In one example, the thermal interface material includes a metal zirconium coil and carbon nanotube arrays, where the metal zirconium coil has a first surface and a second surface that is opposite to the first surface. The carbon nanotubes in the carbon nanotube arrays are distributed on the first surface and the second surface. Further, the first surface and the second surface of the metal zirconium coil include exposed metal zirconium. Therefore, interface thermal resistance of the thermal interface material is reduced, and a heat conducting property of the thermal interface material is improved.

### CROSS-REFERENCE TO RELATED APPLICATION

This application is a continuation of International Application No. PCT/CN2016/090003, filed on Jul. 14, 2016, which claims priority to Chinese Patent Application No. 201511009829.9, filed on Dec. 29, 2015, both of which are hereby incorporated by reference in their entireties.

### TECHNICAL FIELD

The present application relates to the field of material technologies, and in particular, to a thermal interface material, a method for preparing a thermal interface material, a thermally conductive pad, and a heat dissipation system.

### BACKGROUND

Heat generated by a heating element, such as a chip, in an electronic device usually needs to be dissipated to the outside by using a heat dissipation component. From a micro perspective, much roughness exists on a contact interface between the heating element and the heat dissipation component, and a thermal interface material (TIM) needs to be used to fill the contact interface between the heating element and the heat dissipation component, to reduce contact thermal resistance.

Currently, a thermal interface material with a relatively good heat conducting effect in the industry is formed by growing a carbon nanotube array on two surfaces of a metal zirconium coil. However, interface thermal resistance of the metal zirconium coil in the thermal interface material is relatively large. Therefore, a heat conducting property of the thermal interface material is relatively poor.

### SUMMARY

This application provides a thermal interface material, a method for preparing a thermal interface material, a thermally conductive pad, and a heat dissipation system, to reduce interface thermal resistance of the thermal interface material, and improve a heat conducting property of the thermal interface material.

According to a first aspect, an embodiment of this application provides a thermal interface material, including a metal zirconium coil and carbon nanotube arrays. The metal zirconium coil has a first surface and a second surface that is opposite to the first surface. Carbon nanotubes in the carbon nanotube arrays are distributed on the first surface and the second surface, and the first surface and the second surface of the metal zirconium coil include exposed metal zirconium.

In this embodiment of this application, the first surface and the second surface of the metal zirconium coil include the exposed metal zirconium. Therefore, interface thermal resistance of the thermal interface material is reduced, and a heat conducting property of the thermal interface material is improved.

With reference to the first aspect, in a first possible implementation of the first aspect, the first surface and the second surface of the metal zirconium coil are both exposed metal zirconium. When both the two surfaces of the metal zirconium coil are the exposed metal zirconium, the interface thermal resistance of the thermal interface material is further reduced, and the heat conducting property of the thermal interface material is improved.

With reference to the first aspect or the first possible implementation of the first aspect, in a second possible implementation of the first aspect, the carbon nanotubes in the carbon nano arrays are perpendicular to the first surface and the second surface. It should be noted that, herein, the carbon nanotubes in the carbon nano arrays are perpendicular to the first surface and the second surface, but in actual production, not all the carbon nanotubes are perpendicular to the first surface and the second surface. It may be considered that the carbon nanotubes in the carbon nano arrays are perpendicular to the first surface and the second surface provided that an error percentage in the prior art is met. In this case, density of the carbon nanotubes in the carbon nanotube array is relatively even, and there is no density difference that is caused because directions of all the carbon nanotubes are towards a specific side.

With reference to the first aspect, the first possible implementation of the first aspect, or the second possible implementation of the first aspect, in a third possible implementation of the first aspect, a gap between two adjacent carbon nanotubes in the carbon nanotube array is filled with resin, and the resin may be, for example, silicon resin. The interface thermal resistance of the thermal interface material is mainly caused by air that is on an interface and that is between metal oxide on a surface of a metal substrate and a carbon nanotube. In addition, even in a high-density carbon nanotube array, there is still air between carbon nanotubes. Therefore, to reduce the interface thermal resistance of the thermal interface material, a material with higher heat conductivity may be used to replace the air and is filled between the carbon nanotubes.

With reference to the third possible implementation of the first aspect, in a fourth possible implementation of the first aspect, heat conductivity of the resin is greater than 0.1 Watts per meter-Kelvin (W/m.k), so that the heat conducting property of the thermal interface material can be ensured.

With reference to any one of the first aspect, or the first possible implementation of the first aspect to the fourth possible implementation of the first aspect, in a fifth possible implementation of the first aspect, among the nanotubes in the carbon nanotube arrays, density of a carbon nanotube array distributed on the first surface is the same as density of a carbon nanotube array distributed on the second surface.

The carbon nanotubes in the carbon nanotube arrays are evenly distributed on the first surface and the second surface of the metal zirconium coil. Therefore, when the thermal interface material in this embodiment is used, the thermal interface material can be in better contact with a radiator interface, so that the heat conducting property is improved.

With reference to any one of the first aspect, or the first possible implementation of the first aspect to the fifth possible implementation of the first aspect, in a sixth possible implementation of the first aspect, mass density of the carbon nanotubes in the thermal interface material is 0.16 to 0.5 g/cm³.

Higher mass density of the carbon nanotubes in the thermal interface material leads to a better heat conducting effect of the thermal interface material. In this application, the mass density of the carbon nanotubes in the thermal interface material reaches 0.16 to 0.5 g/cm³, and the density may be approximately 10 times mass density of carbon nanotubes in a thermal interface material produced by using a regular growth technology, so that the heat conducting property of the thermal interface material is greatly improved.

With reference to any one of the first aspect, or the first possible implementation to the sixth possible implementation, in a seventh possible implementation, the gap between two adjacent carbon nanotubes in the carbon nanotube array is 10 to 100 nm. A smaller gap between the carbon nanotubes leads to larger density of the carbon nanotubes and a better heat conducting effect. When the gap is smaller, it is difficult to grow a carbon nanotube, and some carbon nanotubes even cannot grow. When the gap between two adjacent carbon nanotubes in the carbon nanotube array is 10 to 100 nm, not only the heat conducting effect of the carbon nanotube array is ensured, but difficulty for growing the carbon nanotube array is not increased.

With reference to any one of the first aspect, or the first possible implementation of the first aspect to the seventh possible implementation of the first aspect, in an eighth possible implementation of the first aspect, thickness of the metal zirconium coil is 10 to 100 μm. Because the carbon nanotubes in this application are in high density, specific thickness of the metal zirconium coil needs to be ensured. Otherwise, even if the carbon nanotubes are evenly distributed, the metal zirconium coil may be prone to deformation. Therefore, the thickness of the metal zirconium coil may be 10 to 100 μm.

With reference to any one of the first aspect, or the first possible implementation of the first aspect to the eighth possible implementation of the first aspect, in a ninth possible implementation of the first aspect, the carbon nanotubes may be multi-walled carbon nanotubes. A diameter of the carbon nanotube may be 10 to 20 nm, and a length may be 30 to 100 μm.

According to a second aspect, an embodiment of this application provides a method for preparing a thermal interface material, including:

growing carbon nanotubes on two surfaces of a metal zirconium coil, to form a carbon nanotube array on each of the two surfaces of the metal zirconium coil; and

performing a reduction reaction on the two surfaces of the metal zirconium coil after the carbon nanotube array is formed on each of the two surfaces of the metal zirconium coil, to obtain the thermal interface material, where the two surfaces of the metal zirconium coil in the thermal interface material include exposed metal zirconium.

The reduction reaction is performed on the two surfaces of the metal zirconium coil after the carbon nanotube array is formed on each of the two surfaces of the metal zirconium coil, so that the two surfaces of the metal zirconium coil in the obtained interface material include the exposed metal zirconium. Therefore, interface thermal resistance of the thermal interface material is reduced, and a heat conducting property of the thermal interface material is improved.

With reference to the second aspect, in a first possible implementation of the second aspect, both the two surfaces of the metal zirconium coil in the thermal interface material are the exposed metal zirconium. When both the two surfaces of the metal zirconium coil are the exposed metal zirconium, the interface thermal resistance of the thermal interface material is further reduced, and the heat conducting property of the thermal interface material is improved.

With reference to the second aspect or the first possible implementation of the second aspect, in a second possible implementation of the second aspect, the performing a reduction reaction on the two surfaces of the metal zirconium coil includes:

placing, in an H₂ atmosphere for annealing reduction processing, the metal zirconium coil with the carbon nanotube array grown on the two surfaces.

A reduction reaction can be performed on H₂ by using an atom O in oxide on the surfaces of the metal zirconium coil, to generate H₂O. Therefore, a good reduction effect is achieved, and the interface thermal resistance of the thermal interface material can be effectively reduced.

With reference to the second possible implementation of the second aspect, in a third possible implementation of the second aspect, the inventor verifies through actual tests that, in a process of performing the annealing reduction processing in the H₂ atmosphere, an optimal effect of performing the reduction reaction on the H₂ by using the atom O in the oxide on the surfaces of the metal zirconium coil is achieved when an H₂ flow rate is 5 to 100 standard cubic centimeters per minute (SCCM), atmospheric pressure is 0.005 to 0.5 Mpa, annealing processing temperature is 350° C. to 650° C., and duration of the annealing processing is 5 to 30 minutes (min).

With reference to any one of the second aspect, or the first possible implementation of the second aspect or the third possible implementation of the second aspect, in a fourth possible implementation of the second aspect, after the performing a reduction reaction on the two surfaces of the metal zirconium coil, the method further includes:

filling a gap between two adjacent carbon nanotubes in the carbon nanotube array with resin in a vacuum by using an evaporation technology, to obtain the thermal interface material.

The interface thermal resistance of the thermal interface material is mainly caused by air that is on an interface and that is between metal oxide on a surface of a metal substrate and a carbon nanotube. In addition, even in a high-density carbon nanotube array, there is still air between carbon nanotubes. Therefore, to reduce the interface thermal resistance of the thermal interface material, a material with higher heat conductivity may be used to replace the air and is filled between the carbon nanotubes.

With reference to the fourth possible implementation of the second aspect, in a fifth possible implementation of the second aspect, a condition of the evaporation technology is that: temperature is 100° C. to 300° C., and working atmospheric pressure is 5 to 50 Torr.

With reference to any one of the second aspect, or the first possible implementation of the second aspect to the fifth possible implementation of the second aspect, in a sixth possible implementation of the second aspect, the growing carbon nanotubes on two surfaces of a metal zirconium coil, to form a carbon nanotube array on each of the two surfaces of the metal zirconium coil includes:

after distributing metal particle catalysts on the two surfaces of the metal zirconium coil, placing, in a vacuum reaction chamber, the metal zirconium coil with the catalysts distributed on the two surfaces, where an airflow diffusion control apparatus is further disposed in the vacuum reaction chamber, the airflow diffusion control apparatus includes a first airflow diffusion control plate and a second airflow diffusion control plate, the first airflow diffusion control plate is located on a side of one surface of the metal zirconium coil, and the second airflow diffusion control plate is located on a side of the other surface of the metal zirconium coil; and

evenly injecting a mixed air source of C₂H₂ and Ar into the vacuum reaction chamber under control, where the mixed air source is blown to the one surface of the metal zirconium coil by using the first airflow diffusion control plate, and the mixed air source is blown to the other surface of the metal zirconium coil by using the second airflow diffusion control plate, to grow the carbon nanotubes on the two surfaces of the metal zirconium coil for 5 to 20 min and form the carbon nanotube array, where total atmospheric pressure in the vacuum reaction chamber is 10 to 100 Torr, and growth temperature is 500° C. to 900° C.

With reference to the sixth possible implementation of the second aspect, in a seventh possible implementation of the second aspect, a distance between the first airflow diffusion control plate and the one surface of the metal zirconium coil is 0.1 mm to 20 mm, a size of a through hole on the first airflow diffusion control plate is 0.1 mm to 10.0 mm, and there is 1 to 100 through holes/cm2. Under such a condition, the mixed air source in the vacuum chamber is blown in an extremely narrow range. Therefore, an air flow can be relatively stable and even, so that the carbon nanotube array grows evenly.

With reference to the seventh possible implementation of the second aspect, in an eighth possible implementation of the second aspect, in the mixed air source, the C₂H₂ takes up 2% to 50%, and the Ar takes up 50% to 98%. A mixed air source within this proportion range can effectively ensure that the carbon nanotubes grow into a high-density carbon nanotube array.

According to a third aspect, an embodiment of this application provides a thermally conductive pad, and the thermally conductive pad is made of the thermal interface material according to the first aspect or any possible implementation of the first aspect.

According to a fourth aspect, an embodiment of this application provides a heat dissipation system, including a heating piece, a radiator, and a thermally conductive pad, where the thermally conductive pad is made of the thermal interface material according to the first aspect or any possible implementation of the first aspect, the heating piece is located on a side of the radiator, and the thermally conductive pad is attached between the heating piece and the radiator, so that the heating piece dissipates heat by transmitting the heat to the radiator by using the thermally conductive pad.

In the embodiments of this application, the first surface and the second surface of the metal zirconium coil include the exposed metal zirconium. Therefore, the interface thermal resistance of the thermal interface material is reduced, and the heat conducting property of the thermal interface material is improved.

### BRIEF DESCRIPTION OF DRAWINGS

FIG. 1 is a schematic diagram of an embodiment of a thermal interface material in this application;

FIG. 2 is a schematic diagram of another embodiment of a thermal interface material in this application;

FIG. 3 is a schematic diagram of an embodiment of a heat dissipation system in this application; and

FIG. 4 is a schematic diagram of an embodiment of a method for preparing a thermal interface material in this application.

### DESCRIPTION OF EMBODIMENTS

This application provides a thermal interface material, a method for preparing a thermal interface material, a thermally conductive pad, and a heat dissipation system, so that interface thermal resistance of the thermal interface material is reduced, and a heat conducting property of the thermal interface material is improved.

To make persons skilled in the art understand the technical solutions of the present application better, the following clearly describes the technical solutions in this application with reference to the accompanying drawings in this application. Apparently, the described embodiments are merely a part rather than all of the embodiments of the present application. All other embodiments obtained by persons of ordinary skill in the art based on the embodiments of the present application without creative efforts shall fall within the protection scope of the present application.

In the specification, claims, and accompanying drawings of the present application, the terms “first”, “second”, and so on (if they exist) are intended to distinguish between similar objects but do not necessarily indicate a specific order or sequence. It should be understood that the data termed in such a way are interchangeable in proper circumstances so that the embodiments described herein can be implemented in other orders than the order illustrated or described herein. Moreover, the terms “include”, “have”, and any other variants mean to cover the non-exclusive inclusion, for example, a process, method, system, product, or device that includes a list of steps or units is not necessarily limited to those units, but may include other steps or units not expressly listed or inherent to such a process, method, system, product, or device.

Related basic concepts in the embodiments of this application are first briefly described below.

Carbon nanotube: is also referred to as a Bucky tube, and is a one-dimensional quantum material with a special structure (a radial dimension is of a nanometer level, an axial dimension is of a micrometer level, and basically, both two ends of the tube are sealed). The carbon nanotube is several layers to dozens of layers of coaxial round tubes that mainly include carbon atoms arranged in a hexagon. There is a fixed distance between layers. The distance is approximately 0.34 nm, and a diameter is usually 2 to 20 nm. In addition, according to different directions along axial directions of carbon hexagons, carbon nanotubes are categorized into three types: zigzag-shaped, armchair-shaped, and spiral. A spiral carbon nanotube has chirality, but zigzag-shaped and armchair-shaped carbon nanotubes do not have chirality. Due to a special molecular structure, the carbon nanotube has an obvious electronic property. The carbon nanotube is widely applied to nanoelectronics and optoelectronics, a field emission electron source, a high-strength composite material, a sensor and an actuator, a heat conducting material, an optical material, a conductive film, a nanometer-level template and hole, and the like.

Ethyne: A molecular formula thereof is C₂H₂. The ethyne is commonly known as air coal and acetylene, and is a member with a smallest volume in an alkyne compound series. The ethyne is mainly for industrial use, for example, growing carbon nanotubes. The ethyne is colorless and extremely flammable gas at room temperature.

Argon: is a nonmetallic element whose element symbol is Ar. Argon is a monatomic molecule, and an elementary substance thereof is colorless, odorless, and tasteless gas. Argon is noble gas with a highest content in the air, and is currently first-discovered noble gas due to a quite high content in the natural world. Argon is extremely chemically inactive. However, a compound of argon, that is, argon fluorohydride has already been manufactured. Argon cannot be combusted, nor is combustion-supporting, and is usually used as protective gas.

An evaporation technology is a method in which metal, an alloy, or a compound used for plating is heated in a vacuum chamber until the metal, the alloy, or the compound melts, so that the metal, the alloy, or the compound effuses in a state of a molecule or an atom, and is deposited on a surface of a to-be-plated material, to form a solid film or coating.

SCCM: is a unit of a volume flow rate. A full English name is standard-state cubic centimeter per minute. SCCM is commonly used in a chemical reaction.

Torr: is a unit of pressure. Originally, 1 Torr is “pressure that lifts mercury in a slim straight pipe by 1 millimeter”. However, regular atmospheric pressure can lift the mercury by 760 mm. Therefore, 1 Torr is defined as 1/760 of the atmospheric pressure.

An embodiment of a thermal interface material according to the embodiments of this application is described below.

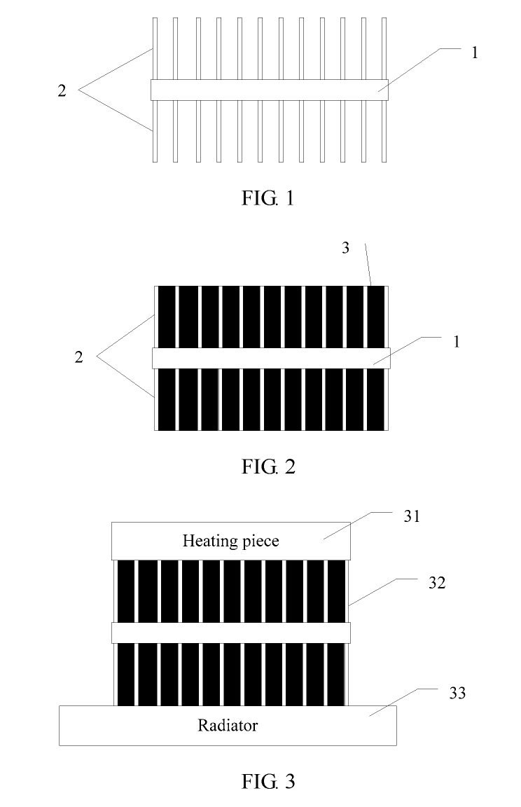

As shown in FIG. 1, an embodiment of a thermal interface material in this application includes a metal zirconium coil 1 and carbon nanotube arrays 2. The metal zirconium coil 1 has a first surface and a second surface that is opposite to the first surface. Carbon nanotubes in the carbon nanotube arrays 2 are distributed on the first surface and the second surface, and the first surface and the second surface of the metal zirconium coil 1 include exposed metal zirconium.

In this embodiment, the first surface and the second surface of the metal zirconium coil include the exposed metal zirconium. Therefore, interface thermal resistance of the thermal interface material is reduced, and a heat conducting property of the thermal interface material is improved.

In this embodiment of this application, to further reduce the interface thermal resistance of the thermal interface material and improve the heat conducting property of the thermal interface material, both the first surface and the second surface of the metal zirconium coil may be the exposed metal zirconium.

Optionally, the carbon nanotubes in the carbon nano arrays are perpendicular to the first surface and the second surface. It should be noted that, herein, the carbon nanotubes in the carbon nano arrays are perpendicular to the first surface and the second surface, but in actual production, not all the carbon nanotubes are perpendicular to the first surface and the second surface. It may be considered that the carbon nanotubes in the carbon nano arrays are perpendicular to the first surface and the second surface provided that an error percentage in the prior art is met. In this case, density of the carbon nanotubes in the carbon nanotube array is relatively even, and there is no density difference that is caused because directions of all the carbon nanotubes are towards a specific side.

The interface thermal resistance of the thermal interface material is mainly caused by air that is on an interface and that is between metal oxide on a surface of a metal substrate and a carbon nanotube. In addition, even in a high-density carbon nanotube array, there is still air between carbon nanotubes. Therefore, to reduce the interface thermal resistance of the thermal interface material, a material with higher heat conductivity may be used to replace the air and is filled between the carbon nanotubes. Optionally, as shown in FIG. 2, a gap between two adjacent carbon nanotubes in the carbon nanotube array is filled with resin, and the resin may be, for example, silicon resin.

When the gap between two adjacent carbon nanotubes in the carbon nanotube array is filled with the resin, further preferably, heat conductivity of the resin is greater than 0.1 W/m.k. In this case, the heat conducting property of the thermal interface material can be ensured.

In some embodiments of this application, among the nanotubes in the carbon nanotube arrays, density of a carbon nanotube array distributed on the first surface is the same as density of a carbon nanotube array distributed on the second surface. It may be understood that the density being the same described herein does not mean that the density is absolutely the same. Instead, in a technology in the art, there is no obvious difference that affects an effect provided that a density difference percentage is met and that the density of the carbon nanotube array distributed on the first surface and the density of the carbon nanotube array distributed on the second surface are even.

The carbon nanotubes in the carbon nanotube arrays are evenly distributed on the first surface and the second surface of the metal zirconium coil. Therefore, when the thermal interface material in this embodiment is used, the thermal interface material can be in better contact with a radiator interface, so that the heat conducting property is improved.

In the thermal interface material including the carbon nanotube, higher mass density of the carbon nanotubes in the thermal interface material leads to a better heat conducting effect of the thermal interface material. In this application, the mass density of the carbon nanotubes in the thermal interface material reaches 0.16 to 0.5 g/cm³, and the density may be approximately 10 times mass density of carbon nanotubes in a thermal interface material produced by using a regular growth technology, so that the heat conducting property of the thermal interface material is greatly improved. In some instances, the mass density of the carbon nanotubes in the thermal interface material is 0.3 to 0.5 g/cm³.

Because the carbon nanotubes in this application are in high density, specific thickness of the metal zirconium coil needs to be ensured. Otherwise, even if the carbon nanotubes are evenly distributed, the metal zirconium coil may be prone to deformation. Therefore, the thickness of the metal zirconium coil may be 10 to 100 μm, and preferably, 30 to 60 μm.

Optionally, in this application, the carbon nanotubes may be multi-walled carbon nanotubes. A diameter of the carbon nanotube may be 10 to 20 nm, and a length may be 30 to 100 μm.

Optionally, the gap between two adjacent carbon nanotubes in the carbon nanotube array is 10 to 100 nm. A smaller gap between the carbon nanotubes leads to larger density of the carbon nanotubes and a better heat conducting effect. Certainly, when the gap between the carbon nanotubes is extremely small, the density of the carbon nanotubes can be further increased. However, when a carbon tube gap of the carbon nanotubes is small to a specific extent, during carbon nanotube growth, growth quality of the carbon nanotubes is prone to degrade and growth difficulty of the carbon nanotubes is increased because of excessively large density. This is mainly due to restriction of a flow rate of carbon source gas (for example, C₂H₂). (That is, the gas cannot smoothly pass through when the carbon nanotubes are extremely dense, and consequently, sufficient and stable carbon sources cannot be provided, and some carbon nanotubes stop growing). Therefore, the gap between the carbon nanotubes needs to be a proper distance. In this embodiment of this application, the gap between two adjacent carbon nanotubes in the carbon nanotube array is 10 to 100 nm, so that not only the heat conducting effect of the carbon nanotube array is ensured, but difficulty for growing the carbon nanotube array is not increased. Further preferably, the gap between two adjacent carbon nanotubes in the carbon nanotube array is 30 to 70 nm.

In an embodiment of this application, a thermally conductive pad is further provided. The thermally conductive pad is made of the foregoing thermal interface material.

In an embodiment of this application, a heat dissipation system is further provided. As shown in FIG. 3, the heat dissipation system includes a heating piece 31, a radiator 32, and a thermally conductive pad 33. The thermally conductive pad 33 is the thermally conductive pad described above. The thermally conductive pad is made of the foregoing thermal interface material. The heating piece 31 is located on a side of the radiator 32. The thermally conductive pad 33 is attached between the heating piece 31 and the radiator, so that the heating piece 31 dissipates heat by transmitting the heat to the radiator 32 by using the thermally conductive pad 33.

The following describes an embodiment of a method for preparing a thermal interface material according to an embodiment of this application.

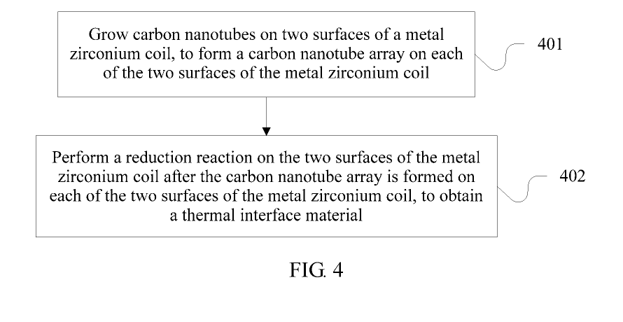

Referring to FIG. 4, an embodiment of a method for preparing a thermal interface material according to an embodiment of this application includes the following steps:

401. Grow carbon nanotubes on two surfaces of a metal zirconium coil, to form a carbon nanotube array on each of the two surfaces of the metal zirconium coil.

402. Perform a reduction reaction on the two surfaces of the metal zirconium coil after the carbon nanotube array is formed on each of the two surfaces of the metal zirconium coil, to obtain the thermal interface material.

The two surfaces of the metal zirconium coil in the thermal interface material include exposed metal zirconium.

In this embodiment, the reduction reaction is performed on the two surfaces of the metal zirconium coil after the carbon nanotube array is formed on each of the two surfaces of the metal zirconium coil, so that the two surfaces of the metal zirconium coil in the obtained interface material include the exposed metal zirconium. Therefore, interface thermal resistance of the thermal interface material is reduced, and a heat conducting property of the thermal interface material is improved.

Optionally, both the two surfaces of the metal zirconium coil in the thermal interface material are the exposed metal zirconium. When both the two surfaces of the metal zirconium coil are the exposed metal zirconium, the interface thermal resistance of the thermal interface material is further reduced, and the heat conducting property of the thermal interface material is improved.

Optionally, the performing a reduction reaction on the two surfaces of the metal zirconium coil includes:

placing, in an H₂ atmosphere for annealing reduction processing, the metal zirconium coil with the carbon nanotube array grown on the two surfaces.

A reduction reaction can be performed on H₂ by using an atom O in oxide on the surfaces of the metal zirconium coil, to generate H₂O. Therefore, a good reduction effect is achieved, and the interface thermal resistance of the thermal interface material can be effectively reduced.

Optionally, the inventor verifies through actual tests that, in a process of performing the annealing reduction processing in the H₂ atmosphere, an optimal effect of performing the reduction reaction on the H₂ by using the atom O in the oxide on the surfaces of the metal zirconium coil is achieved when an H₂ flow rate is 5 to 100 SCCM, atmospheric pressure is 0.005 to 0.5 Mpa, annealing processing temperature is 350° C. to 650° C., and duration of the annealing processing is 5 to 30 min.

The interface thermal resistance of the thermal interface material is mainly caused by air that is on an interface and that is between metal oxide on a surface of a metal substrate and a carbon nanotube. In addition, even in a high-density carbon nanotube array, there is still air between carbon nanotubes. Therefore, to reduce the interface thermal resistance of the thermal interface material, a material with higher heat conductivity may be used to replace the air and is filled between the carbon nanotubes. Optionally, after the performing a reduction reaction on the two surfaces of the metal zirconium coil, the method further includes:

filling a gap between two adjacent carbon nanotubes in the carbon nanotube array with resin in a vacuum by using an evaporation technology, to obtain the thermal interface material.

Optionally, a condition of the evaporation technology is that: temperature is 100° C. to 300° C., and working atmospheric pressure is 5 to 50 Torr.

Optionally, the growing carbon nanotubes on two surfaces of a metal zirconium coil, to form a carbon nanotube array on each of the two surfaces of the metal zirconium coil includes:

after distributing metal particle catalysts on the two surfaces of the metal zirconium coil, placing, in a vacuum reaction chamber, the metal zirconium coil with the catalysts distributed on the two surfaces, where an airflow diffusion control apparatus is further disposed in the vacuum reaction chamber, the airflow diffusion control apparatus includes a first airflow diffusion control plate and a second airflow diffusion control plate, the first airflow diffusion control plate is located on a side of one surface of the metal zirconium coil, and the second airflow diffusion control plate is located on a side of the other surface of the metal zirconium coil; and

evenly injecting a mixed air source of C₂H₂ and Ar into the vacuum reaction chamber under control, where the mixed air source is blown to the one surface of the metal zirconium coil by using the first airflow diffusion control plate, and the mixed air source is blown to the other surface of the metal zirconium coil by using the second airflow diffusion control plate, to grow the carbon nanotubes on the two surfaces of the metal zirconium coil for 5 to 20 min and form the carbon nanotube array, where total atmospheric pressure in the vacuum reaction chamber is 10 to 100 Torr, and growth temperature is 500° C. to 900° C.

Optionally, a distance between the first airflow diffusion control plate and the one surface of the metal zirconium coil is 0.1 mm to 20 mm, a size of a through hole on the first airflow diffusion control plate is 0.1 mm to 10.0 mm, and there is 1 to 100 through holes/cm2. Under such a condition, the mixed air source in the vacuum chamber is blown in an extremely narrow range. Therefore, an air flow can be relatively stable and even, so that the carbon nanotube array grows evenly.

Optionally, in the mixed air source, the C₂H₂ takes up 2% to 50%, and the Ar takes up 50% to 98%. A mixed air source within this proportion range can effectively ensure that the carbon nanotubes grow into a high-density carbon nanotube array.

It may be clearly understood by persons skilled in the art that, for the purpose of convenient and brief description, for a detailed working process of the foregoing system, apparatus, and unit, refer to a corresponding process in the foregoing method embodiments, and details are not described herein again. In the foregoing embodiments, the description of each embodiment has respective focuses. For a part that is not described in detail in an embodiment, refer to related descriptions in other embodiments.

It should be noted that, to make the description brief, the foregoing method embodiments are expressed as a series of actions. However, persons skilled in the art should appreciate that the present application is not limited to the described action sequence, because according to the present application, some steps may be performed in other sequences or performed simultaneously. In addition, persons skilled in the art should also appreciate that all the embodiments described in the specification are preferred embodiments, and the related actions and modules are not necessarily mandatory to the present application.

In the several embodiments provided in this application, it should be understood that the disclosed system, apparatus, and method may be implemented in other manners. For example, the apparatus embodiment described above is merely an example.

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. A thermal interface material, comprising a metal zirconium coil and carbon nanotube arrays, wherein the metal zirconium coil has a first surface and a second surface opposite to the first surface, wherein carbon nanotubes in the carbon nanotube arrays are distributed on the first surface and the second surface, and wherein the first surface and the second surface of the metal zirconium coil comprise exposed metal zirconium.

2. The material according to claim 1, wherein both the first surface of the metal zirconium coil and the second surface of the metal zirconium coil are the exposed metal zirconium.

3. The material according to claim 1, wherein the carbon nanotubes in the carbon nanotube arrays are perpendicular to the first surface and the second surface.

4. The material according to claim 1, wherein a gap between two adjacent carbon nanotubes in the carbon nanotube array is filled with resin.

5. The material according to claim 4, wherein heat conductivity of the resin is greater than 0.1 W/m.k.

6. The material according to claim 1, wherein, among the nanotubes in the carbon nanotube arrays, density of a carbon nanotube array distributed on the first surface is the same as density of a carbon nanotube array distributed on the second surface.

7. The material according to claim 1, wherein mass density of the carbon nanotubes in the thermal interface material is 0.16 to 0.5 g/cm³.

8. The material according to claim 1, wherein the gap between two adjacent carbon nanotubes in the carbon nanotube array is 10 to 100 nm.

9. The material according to claim 1, wherein thickness of the metal zirconium coil is 10 to 100 μm.

10. A method for preparing a thermal interface material, comprising:
growing carbon nanotubes on two surfaces of a metal zirconium coil to form a carbon nanotube array on each of the two surfaces of the metal zirconium coil; and
performing a reduction reaction on the two surfaces of the metal zirconium coil after the carbon nanotube array is formed on each of the two surfaces of the metal zirconium coil to obtain the thermal interface material, wherein the two surfaces of the metal zirconium coil in the thermal interface material comprise exposed metal zirconium.

11. The method according to claim 10, wherein both the two surfaces of the metal zirconium coil in the thermal interface material are the exposed metal zirconium.

12. The method according to claim 10, wherein the performing the reduction reaction on the two surfaces of the metal zirconium coil comprises:
placing the metal zirconium coil with the carbon nanotube array grown on the two surfaces in an H₂ atmosphere for annealing reduction processing.

13. The method according to claim 12, wherein in a process of the annealing reduction processing in the H₂ atmosphere, an H₂ flow rate is 5 to 100 SCCM, atmospheric pressure is 0.005 to 0.5 MPa, annealing processing temperature is 350° C. to 650° C., and duration of the annealing processing is 5 to 30 minutes.

14. The method according to claim 10, wherein after the performing the reduction reaction on the two surfaces of the metal zirconium coil, the method further comprises:
filling a gap between two adjacent carbon nanotubes in the carbon nanotube array with resin in a vacuum by using an evaporation technology to obtain the thermal interface material.

15. The method according to claim 14, wherein a condition of the evaporation technology is that:
temperature is 100° C. to 300° C., and working atmospheric pressure is 5 to 50 Torr.

16. The method according to claim 10, wherein the growing carbon nanotubes on two surfaces of a metal zirconium coil to form a carbon nanotube array on each of the two surfaces of the metal zirconium coil comprises:
after distributing metal particle catalysts on the two surfaces of the metal zirconium coil, placing the metal zirconium coil with the catalysts distributed on the two surfaces in a vacuum reaction chamber, wherein an airflow diffusion control apparatus is further disposed in the vacuum reaction chamber, wherein the airflow diffusion control apparatus comprises a first airflow diffusion control plate and a second airflow diffusion control plate, wherein the first airflow diffusion control plate is located on a side of one surface of the metal zirconium coil, and wherein the second airflow diffusion control plate is located on a side of the other surface of the metal zirconium coil; and
evenly injecting a mixed air source of C₂H₂ and Ar into the vacuum reaction chamber under control, wherein the mixed air source is blown to the one surface of the metal zirconium coil by using the first airflow diffusion control plate, and wherein the mixed air source is blown to the other surface of the metal zirconium coil by using the second airflow diffusion control plate, to grow the carbon nanotubes on the two surfaces of the metal zirconium coil for 5 to 20 minutes and form the carbon nanotube array, wherein total atmospheric pressure in the vacuum reaction chamber is 10 to 100 Torr, and growth temperature is 500° C. to 900° C.

17. The method according to claim 16, wherein a distance between the first airflow diffusion control plate and the one surface of the metal zirconium coil is 0.1 mm to 20 mm, wherein a size of a through hole on the first airflow diffusion control plate is 0.1 mm to 10.0 mm, and wherein there is 1 to 100 through holes/cm².

18. The method according to claim 17, wherein a distance between the second airflow diffusion control plate and the other surface of the metal zirconium coil is 0.1 mm to 20 mm, wherein a size of a through hole on the second airflow diffusion control plate is 0.1 mm to 10.0 mm, and wherein there is 1 to 100 through holes/cm².

19. The method according to claim 16, wherein, in the mixed air source, the C₂H₂ takes up 2% to 50%, and the Ar takes up 50% to 98%.

20. A heat dissipation system, comprising:
a heating piece;
a radiator; and
a thermally conductive pad, wherein the thermally conductive pad is made of thermal interface material comprising a metal zirconium coil and carbon nanotube arrays, wherein the metal zirconium coil has a first surface and a second surface opposite to the first surface, wherein carbon nanotubes in the carbon nanotube arrays are distributed on the first surface and the second surface, and wherein the first surface and the second surface of the metal zirconium coil comprise exposed metal zirconium;
wherein the heating piece is located on a side of the radiator; and
wherein the thermally conductive pad is attached between the heating piece and the radiator, and wherein the heating piece is configured to dissipate heat by transmitting the heat to the radiator by using the thermally conductive pad.
